(19) United States
(12) Patent Application Publication
(10) Pub. No.: US 2023/0373754 A1
(43) Pub. Date: Nov. 23, 2023

(54) ELEVATOR COMMUNICATION SYSTEM, A METHOD AND AN APPARATUS

(71) Applicant: KONE Corporation, Helsinki (FI)

(72) Inventor: Ari Kattainen, Helsinki (FI)

(73) Assignee: KONE Corporation, Helsinki (FI)

(21) Appl. No.: 18/228,368

(22) Filed: Jul. 31, 2023

Related U.S. Application Data
(63) Continuation of application No. PCT/EP2021/052323, filed on Feb. 1, 2021.

(51) Int. Cl. B66B 3/00; B66B 1/34; B66B 5/00; B66B 5/02

(52) U.S. Cl. CPC B66B 3/002; B66B 1/3461; B66B 5/0006; B66B 5/024

(57) ABSTRACT

An elevator communication system includes an elevator communication network configured to carry elevator system associated data; a plurality of elevator system nodes communicatively connected to the elevator communication network, wherein at least some of the plurality of elevator system nodes each includes a camera associated with an elevator and/or a landing floor served by the elevator and configured to provide image data about the elevator and/or the landing floor, wherein at least some of the plurality of elevator system nodes each includes a sensor associated with an elevator and a landing floor served by the elevator and configured to provide sensor data for at least one parameter associated with the elevator and/or the landing floor, and wherein at least one of the plurality of elevator system nodes includes a display node, and a controller communicatively connected to the elevator communication network. The controller is configured to obtain image data from a plurality of cameras and sensor data from a plurality of sensors during a fire emergency situation; and cause display, during the fire emergency situation, with the at least one display node a graphical user interface comprising image data and sensor data associated with a selected set of the plurality of cameras and sensors.

### TECHNICAL FIELD

The present application relates to the field of elevator communication systems.

### BACKGROUND

In modern elevator system, elevators can be controlled efficiently to transport passenger between floors in a building. However, sometimes it may happen, for example, in a fire emergency situation elevators are used by the rescue personnel to reach various floors of a building. The fire situation experienced in various landing floor and by elevators may vary significantly, and the rescue personnel may not always have up to date information about the situation in different parts of a building.

Thus, it would be beneficial to have a solution that would alleviate at least one of these drawbacks.

### SUMMARY

According to a first aspect, there is provided an elevator communication system comprising an elevator communication network configured to carry elevator system associated data, a plurality of elevator system nodes communicatively connected to the elevator communication network, wherein at least some of the plurality of elevator system nodes each comprises a camera associated with an elevator and/or a landing floor served by the elevator and configured to provide image data about the elevator and/or the landing floor, wherein at least some of the plurality of elevator system nodes each comprises a sensor associated with the elevator and/or the landing floor served by the elevator and configured to provide sensor data for at least one parameter associated with an elevator and/or a landing floor, and wherein at least one of the plurality of elevator system nodes comprises a display node, and a controller communicatively connected to the elevator communication network. The controller is configured to obtain image data from a plurality of cameras and sensor data from a plurality of sensors during a fire emergency situation; and cause display, during the fire emergency situation, with the at least one display node a graphical user interface comprising image data and sensor data associated with a selected set of the plurality of cameras and sensors.

In an implementation form of the first aspect, the graphical user interface comprises a summary of sensor data associated with the selected set of the plurality of the sensors.

In an implementation form of the first aspect, the graphical user interface comprises a separate miniature image frame for image data of each camera.

In an implementation form of the first aspect, the controller is configured to receive information indicating a selection of a landing floor; and provide more detailed sensor data associated with the selected landing floor.

In an implementation form of the first aspect, the controller is configured to receive information indicating a selection of a landing floor; and provide an expanded image frame comprising image data associated with the selected landing floor and more detailed sensor data associated with the selected landing floor.

In an implementation form of the first aspect, the information indicating a selection of a landing floor is received in response to a selection of landing floor via the graphical user interface.

In an implementation form of the first aspect, the information indicating a selection of a landing floor is received in response to a selection of landing floor via a car call button in an elevator car.

In an implementation form of the first aspect, the sensor data associated with the selected set of the plurality of elevators and the plurality of landing floors comprises a progression of the at least one parameter in time domain.

In an implementation form of the first aspect, the plurality of sensors comprises at least one of a temperature sensor, a carbon monoxide sensor, an air moisture sensor, and a carbon dioxide sensor.

In an implementation form of the first aspect, the display node comprises at least one of a display node arranged in an elevator car, a display node arranged at a fire service access level, and a display node arranged in a command center.

In an implementation form of the first aspect, the elevator communication network comprises at least one point-to-point ethernet network.

In an implementation form of the first aspect, the elevator communication network comprises at least one multi-drop ethernet segment.

According to a second aspect, there is provided a method comprising: obtaining, by a controller communicatively connected to an elevator communication network, image data from a plurality of cameras communicatively connected to the elevator communication network and sensor data from a plurality of sensors communicatively connected to the elevator communication network during a fire emergency situation, each of the plurality of cameras being associated with an elevator and/or landing floor served by the elevator and configured to provide image data about the elevator and/or the landing floor, each of the plurality of sensors being associated with an elevator and/or a landing floor served by the elevator and configured to provide sensor data for at least one parameter associated with the elevator and/or the landing floor; and causing display, by the controller, during the fire emergency situation, with at least one display node communicatively connected to the elevator communication network a graphical user interface comprising image data and sensor data associated with a selected set of the plurality of cameras and sensors.

In an implementation form of the second aspect, the graphical user interface comprises a summary of sensor data associated with the selected set of the plurality of sensors.

In an implementation form of the second aspect, the graphical user interface comprises a separate miniature image frame for image data of each camera.

In an implementation form of the second aspect, the method further comprises receiving information indicating a selection of a landing floor; and providing more detailed sensor data associated with the selected landing floor.

In an implementation form of the second aspect, the method further comprises receiving information indicating a selection of a landing floor; and providing an expanded image frame comprising image data associated with the selected landing floor and more detailed sensor data associated with the selected landing floor.

In an implementation form of the second aspect, the information indicating a selection of a landing floor is received in response to a selection of landing floor via the graphical user interface.

In an implementation form of the second aspect, the information indicating a selection of a landing floor is received in response to a selection of landing floor via a car call button in an elevator car.

In an implementation form of the second aspect, the sensor data associated with the selected set of the plurality of sensors associated with the elevators and the landing floors served by the elevators comprises a progression of the at least one parameter in time domain.

In an implementation form of the second aspect, the plurality of sensors comprises at least one of a temperature sensor, a carbon monoxide sensor, an air moisture sensor, and a carbon dioxide sensor.

In an implementation form of the second aspect, the display node comprises at least one of a display node arranged in an elevator car, a display node arranged at a fire service access level, and a display node arranged in a command center.

In an implementation form of the second aspect, the elevator communication network comprises at least one point-to-point ethernet network.

In an implementation form of the second aspect, the elevator communication network comprises at least one multi-drop ethernet segment.

According to a third aspect, there is provided an apparatus communicatively connected to an elevator communication network. The apparatus comprises means for obtaining image data from a plurality of cameras communicatively connected to the elevator communication network and sensor data from a plurality of sensors communicatively connected to the elevator communication network during a fire emergency situation, each of the plurality of cameras being associated with an elevator and landing floor served by the elevator and configured to provide image data about the elevator and/or the landing floor, each of the plurality of sensors being associated with an elevator and/or a landing floor served by the elevator and configured to provide sensor data for at least one parameter associated with the elevator and/or the landing floor; and means for causing display during the fire emergency situation, with at least one display node communicatively connected to the elevator communication network a graphical user interface comprising image data and sensor data associated with a selected set of the plurality of cameras and sensors.

According to a fourth aspect, there is provided an elevator system comprising an elevator communication system of any of the first aspect.

According to a fifth aspect, there is provided a computer program comprising program code, which when executed by at least one processing unit, causes the at least one processor to perform the method of the third aspect.

According to a sixth aspect, there is provided a computer readable medium comprising program code, which when executed by at least one processor, causes the at least one processor to perform the method of the third aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates an elevator communication system according to an example embodiment.

FIG. 1B illustrates an elevator communication system according to another example embodiment.

FIG. 2 illustrates an apparatus for controlling an elevator communication system according to an embodiment.

FIG. 3 illustrates a method according to an example embodiment.

FIG. 4A illustrates a simplified graphical user interface provided by a controller according to an example embodiment.

FIG. 4B illustrates a simplified graphical user interface provided by a controller according to an example embodiment.

FIG. 4C illustrates a simplified graphical user interface provided by a controller according to another example embodiment.

FIG. 4D illustrates a simplified graphical user interface provided by a controller according to another example embodiment.

### DETAILED DESCRIPTION

The following description illustrates an elevator communication system that comprises an elevator communication network configured to carry elevator system associated data, a plurality of elevator system nodes communicatively connected to the elevator communication network. At least some of the plurality of elevator system nodes each comprises a camera associated with an elevator and/or landing floor served by the elevator and configured to provide image data about the elevator and/or the landing floor. At least some of the plurality of elevator system nodes each comprises a sensor associated with an elevator and/or a landing floor served by the elevator and configured to provide sensor data for at least one parameter associated with the elevator and/or the landing floor. At least one the plurality of elevator system nodes comprises a display node. The elevator communication network further comprises a controller communicatively connected to the elevator communication network. The controller is configured to obtain image data from a plurality of cameras and sensor data from a plurality of sensors during a fire emergency situation; and cause display, during the fire emergency situation, with the at least one display node a graphical user interface comprising image data and sensor data associated with a selected set of the plurality of sensors associated with the elevators and the landings floors served by the elevators. The illustrated solution enables that more accurate information is available for the rescue personnel in a fire emergency situation and that the rescue personnel is able to adapt their actions based on the obtained information.

In an example embodiment, the various embodiments discussed below may be used in an elevator system comprising an elevator that is suitable and may be used for transferring passengers between landing floors of a building in response to service requests. In another example embodiment, the various embodiments discussed below may be used in an elevator system comprising an elevator that is suitable and may be used for automated transferring of passengers between landings in response to service requests.

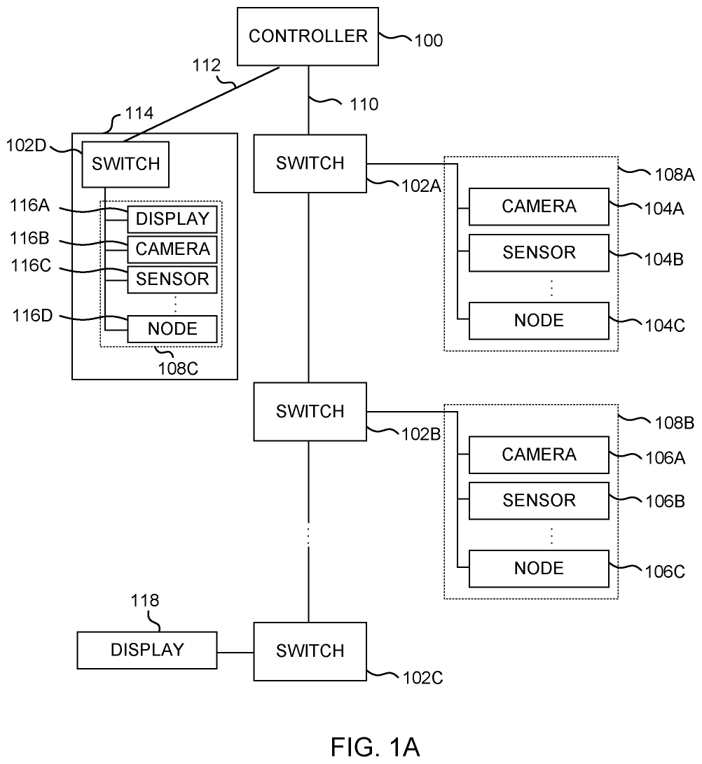

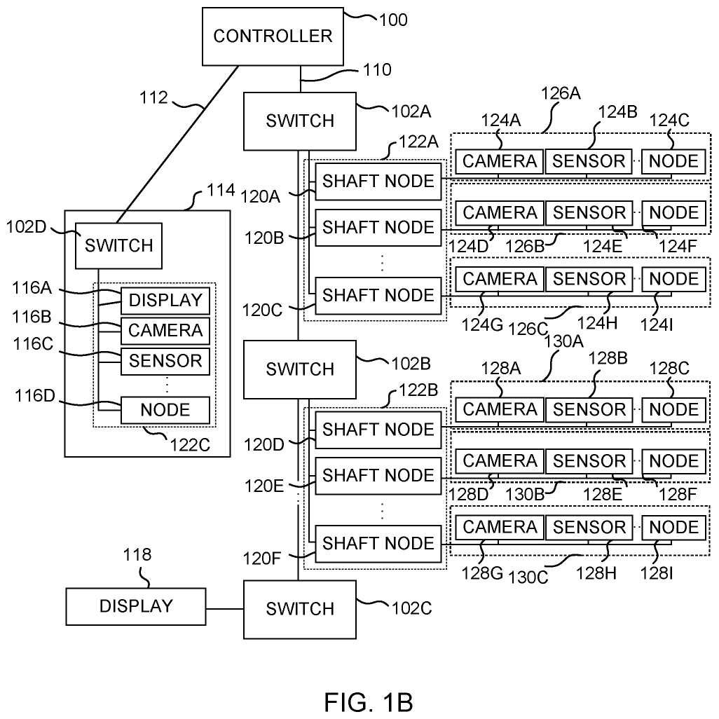

FIG. 1A illustrates an elevator communication system according to an example embodiment. The elevator communication system may comprise a controller 100. The elevator communication system further comprises an elevator communication network configured to carry elevator system associated data. The elevator communication network may be an ethernet-based communication network and it may comprise at least one point-to-point ethernet bus 110, 112 and/or at least one multi-drop ethernet segment 108A, 108B, 108C. The point-to-point ethernet bus may be, for example, a 100BASE-TX or a 10BASET1L point-to-point ethernet bus. The multi-drop ethernet bus segments may comprise, for example, 10BASE-T1S multi-drop ethernet bus. The controller 100 may be, for example, an elevator controller or other controlling entity being communicatively connected to the elevator communication network.

In an example embodiment, the elevator communication system may comprise at least one connecting unit 102A, 102B, 102C comprising a first port connected to the respective multi-drop ethernet bus segments 108A, 108B and a second port connected to the point-to-point ethernet bus 110. Thus, by using the connecting units 102A, 102B, 102C, one or more multi-drop ethernet bus segments 108A, 108B may be connected to the point-to-point ethernet bus 110. The connecting unit 102A, 102B, 102C may refer, for example, to a switch.

The elevator communication system may comprise a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A-116D may be connected. In an example embodiment, the elevator car nodes 116A-116D may be connected to the connecting unit 102D via a multi-drop ethernet bus segment 108C, thus constituting an elevator car segment 108C. In an example embodiment, the point-to-point-ethernet bus 112 may be located in the travelling cable of the elevator car 114.

The elevator communication system may further comprise one or more multi-drop ethernet bus segments 108A, 108B (for example, in the form of 10BASE-T1S) reachable by the controller 100, and a plurality of elevator system nodes 104A-104C, 106A-106C coupled to the multi-drop ethernet bus segments 108A, 108B and configured to communicate via the multi-drop ethernet bus segments 108A, 108B. The controller 100 is reachable by the elevator system nodes 104A-104C, 106A-106C via the multi-drop ethernet bus segments 108A, 108B. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 104A-140C, 106A-106C may be configured to interface with at least one of an elevator fixture, at least one sensor, an elevator safety device, a camera, audio means (for example, a microphone and/or a loudspeaker), and an elevator control device. Further, in an example embodiment, power to the nodes may be provided with the same cabling. In another example embodiment, the elevator system nodes 104A-140C, 106A-106C may comprise shaft nodes, and a plurality of shaft nodes may form a shaft segment, for example, the multi-drop ethernet bus segment 108A, 108B.

At least some of the plurality of elevator system nodes 104A-104C, 106A-106C, 116A-116D, 118 each may comprise a camera 104A, 106A associated with different landing floors, respectively, configured to provide image data about a respective landing floor area and a camera 116B configured to provide image data from the elevator car 114. The image data may comprise still image data or video data. The camera 104A, 106A may be integrated into a respective landing floor display which is located, for example, above the landing doors. The camera 104A, 106A may also be integrated into an elevator call device arranged at the landing floor. The plurality of elevator system nodes 104A-104C, 106A-106C, 116A-116C, 118 may also comprise a display 116A arranged in the elevator car 114 and/or a display 118 connected directly to the switch 102C. For example, during a normal elevator use, the display 116A may be used as an infotainment device for passengers. In a fire emergency situation, the display 116A may be configured to display data provided by at least one of the cameras 104A, 106A. The elevator car 114 may also comprise at least one speaker and microphone. The plurality of elevator system nodes 104A-104C, 106A-106C, 116A-116C, 118 may also comprise at least one sensor 104B, 106B, 116C arranged in the elevator car and/or at a landing floor and configured to provide sensor data for at least one parameter associated with the elevators and the landing floors. The sensor may comprise, for example, a temperature sensor, a carbon monoxide sensor, an air moisture sensor, or a carbon dioxide sensor.

FIG. 1B illustrates an elevator communication system according to another example embodiment. The elevator communication system may comprise a controller 100. The elevator communication system further comprises an elevator communication network configured to carry elevator system associated data. The elevator communication network may be an ethernet-based communication network and it may comprise at least one point-to-point ethernet 110, 112 bus and/or at least one multi-drop ethernet segment. The point-to-point ethernet bus may be, for example, a 100BASE-TX or a 10BASET1L point-to-point ethernet bus. The multi-drop ethernet bus segments may comprise, for example, a 10BASE-T1S multi-drop ethernet bus. The controller 100 may be, for example, an elevator controller or other controlling entity being communicatively connected to the elevator communication network.

In an example embodiment, the elevator communication system may comprise at least one connecting unit 102A, 102B, 102C comprising a first port connected to the respective multi-drop ethernet bus segments 122A, 122B and a second port connected to the point-to-point ethernet bus 110. Thus, by using the connecting units 102A, 102B, 102C, one or more multi-drop ethernet bus segments 122A, 122B may be connected to the point-to-point ethernet bus 110. The connecting unit 102A, 102B, 102C may refer, for example, to a switch.

The elevator communication system may comprise a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A-116Dmay be connected. In an example embodiment, the elevator car nodes 116A-116D may be connected to the connecting unit 102D via a multi-drop ethernet bus segment 122C, thus constituting an elevator car segment 122C. In an example embodiment, the point-to-point-ethernet bus 112 is located in the travelling cable of the elevator car 114.

The elevator communication system may further comprise one or more multi-drop ethernet bus segments 122A, 122B, 126A-126C, 130A-130C (for example, in the form of 10BASE-T1S) reachable by the controller 100, and a plurality of elevator system nodes 120A-120F, 124A-124I, 128A-128I coupled to the multi-drop ethernet bus segments 122A, 122B, 126A-126C, 130A-130C and configured to communicate via the multi-drop ethernet bus segments 122A, 122B, 126A-126C, 130A-130C. The controller 100 is reachable by the elevator system nodes 120A-120F, 124A-124I, 128A-128I via the multi-drop ethernet bus segments 122A, 122B, 126A-126C, 130A-130C. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 116A-116C, 124A-124IC, 130A-130I may be configured to interface with at least one of an elevator fixture, a sensor, an elevator safety device, a camera, audio means (for example, a microphone and/or a loudspeaker), and an elevator control device. Further, in an example embodiment, power to the nodes may be provided with the same cabling. In another example embodiment, the elevator system nodes 120A-120F may comprise shaft nodes, and a plurality of shaft nodes may form a shaft segment, for example, the multi-drop ethernet bus segment 122A, 122B.

At least some of the plurality of elevator system nodes 116A-116C, 118, 124A-124I, 128A-128I each may comprise a camera 124A, 124D, 124G, 128A, 128D, 128G associated with different landing floors configured to provide image data about a respective landing floor area. The camera 124A, 124D, 124G, 128A, 128D, 128G may be integrated into a respective landing floor display which is located, for example, above the landing doors. The camera 124A, 124D, 124G, 128A, 128D, 128G may also be integrated into an elevator call device arranged at the landing floor. One or more of the plurality of elevator system nodes 116A-116C, 118, 124A-124I, 128A-128I may also comprise a display 116A arranged in the elevator car 114 and/or a display 118 connected directly to the switch 102C. For example, during a normal elevator use, the display 116A may be used as an infotainment device for passengers. In an evacuation situation, the display 116A may be configured to display data provided by at least one of the cameras 124A, 124D, 124G, 128A, 128D, 128G. The elevator car 114 may also comprise at least one speaker and microphone. At least some of the plurality of elevator system nodes 116A-116C, 118, 124A-124I, 128A-128I each may comprise a sensor 116C, 124B, 124E, 124H, 128A, 128E, 128H arranged in the elevator car 114 and/or at a landing floor and configured to provide sensor data for at least one parameter associated with the elevators and the landing floors. The sensor may comprise, for example, a temperature sensor, a carbon monoxide sensor, an air moisture sensor or a carbon dioxide sensor.

By implementing communication within the elevator communication system using at least one point-to-point ethernet bus and at least one multi-drop ethernet bus segment, various segments can be formed within the elevator communication system. For example, the elevator system nodes 124A-124C may form a first landing segment 126A, the elevator system nodes 124D-124F may form a second landing segment 126B, the elevator system nodes 124G-124I may form a third landing segment 126C, the shaft nodes 120A-120C may form a first shaft segment 122A, the shaft nodes 120D-120F may form a second shaft segment 122B, and the elevator car nodes 116A-116C may form an elevator car segment 122C. Each of the segments 122A-122C, 126A-126C may be implemented using separate multi-drop ethernet buses.

As illustrated in FIG. 1B, the shaft nodes 120A-120F interconnect the shaft segments 122A, 122B to which the shaft nodes 124A-124I, 128A-128I are connected to and the landing segments 126A-126C. In other words, the shaft nodes 120A-120C may comprise or may act as a switch to the landing segments 126A-126C, 130A-130C. This may enable a simple solution for adding new elevator system nodes to the elevator communication system. This may also enable a solution in which a single elevator system node may act as a switch or a repeater to another multi-drop ethernet bus segment to which nearby elevator system elements, for example, a call button or buttons, a display or displays, a destination operating panel or panels, a camera or cameras, a voice intercom device etc. may be connected.

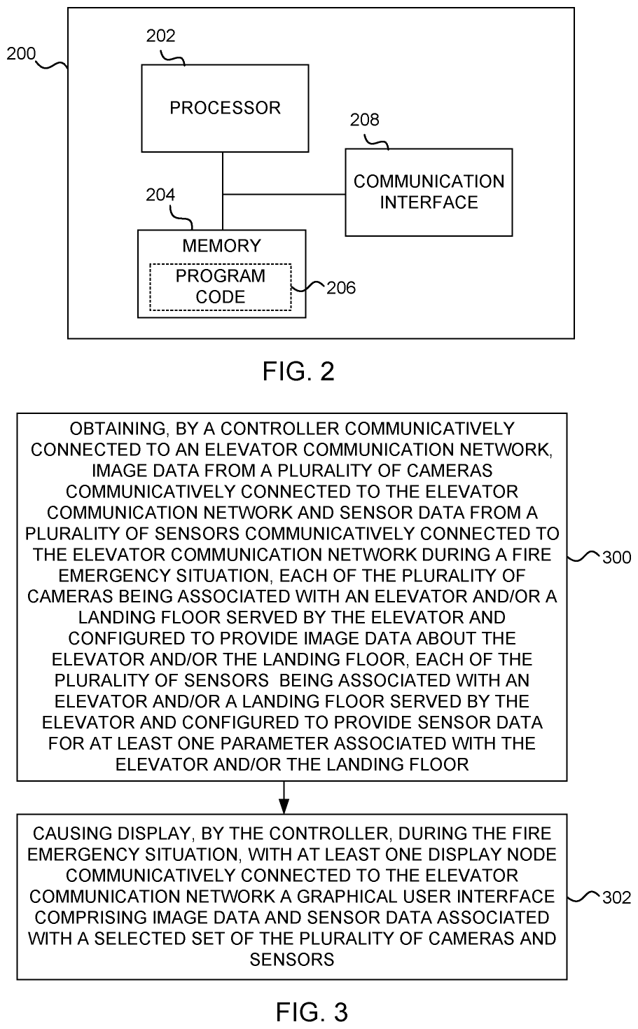

FIG. 2 illustrates a controller 200 for controlling an elevator communication system according to an embodiment. The controller 200 may comprise at least one processor 202. The controller 200 may further comprise at least one memory 204. The memory 204 may comprise program code 206 which, when executed by the processor 202 causes the controller 200 to perform at least one example embodiment. The exemplary embodiments and aspects of the subject-matter can be included within any suitable device, for example, including, servers, elevator controllers, workstations, capable of performing the processes of the exemplary embodiments. The exemplary embodiments may also store information relating to various processes described herein. Although the controller 200 is illustrated as a single device it is appreciated that, wherever applicable, functions of the controller 200 may be distributed to a plurality of devices. The controller 200 may be, for example, an elevator controller or other controlling entity being communicatively connected to the elevator communication network.

Example embodiments may be implemented in software, hardware, application logic or a combination of software, hardware and application logic. The example embodiments can store information relating to various methods described herein. This information can be stored in one or more memories 204, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases. Further, the illustrated embodiments and method steps may be implemented as a computer-implemented solution.

The processor 202 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s).

Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 204 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The controller 200 may comprise a communication interface 208 configured to enable the controller 200 to transmit and/or receive information, to/from other apparatuses.

The controller 200 may comprise means for performing at least one method described herein. In one example, the means may comprise the at least one processor 202, the at least one memory 204 including program code 206 configured to, when executed by the at least one processor 202, cause the controller 200 to perform the method.

FIG. 3 illustrates a method according to an example embodiment. The method may be performed, for example, in an elevator communication system illustrated in any of FIGS. 1A-1B.

At 300, image data is obtained by the controller 100 from a plurality of cameras 104A, 106A, 116B, 124A, 124D, 124G, 128A, 128D, 128G communicatively connected to the elevator communication network and sensor data from the plurality of sensors 104B, 106B, 116C, 124B, 124E, 124H, 128B, 128E, 128H communicatively connected to the elevator communication network during a fire emergency situation. The controller 100 may be, for example, an elevator controller or other controlling entity being communicatively connected to the elevator communication network.

At 302 the controller 100 causes display, during the fire emergency situation, of a graphical user interface comprising image data and sensor data associated with a selected set of the plurality of cameras and sensor with at least one display node 116A, 118 communicatively connected to the elevator communication network.

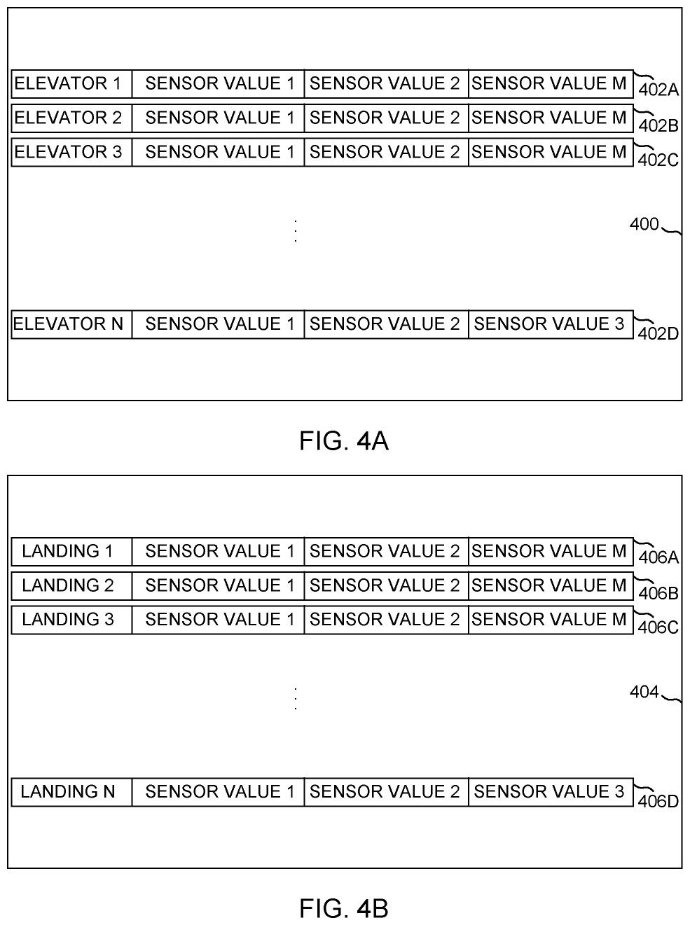

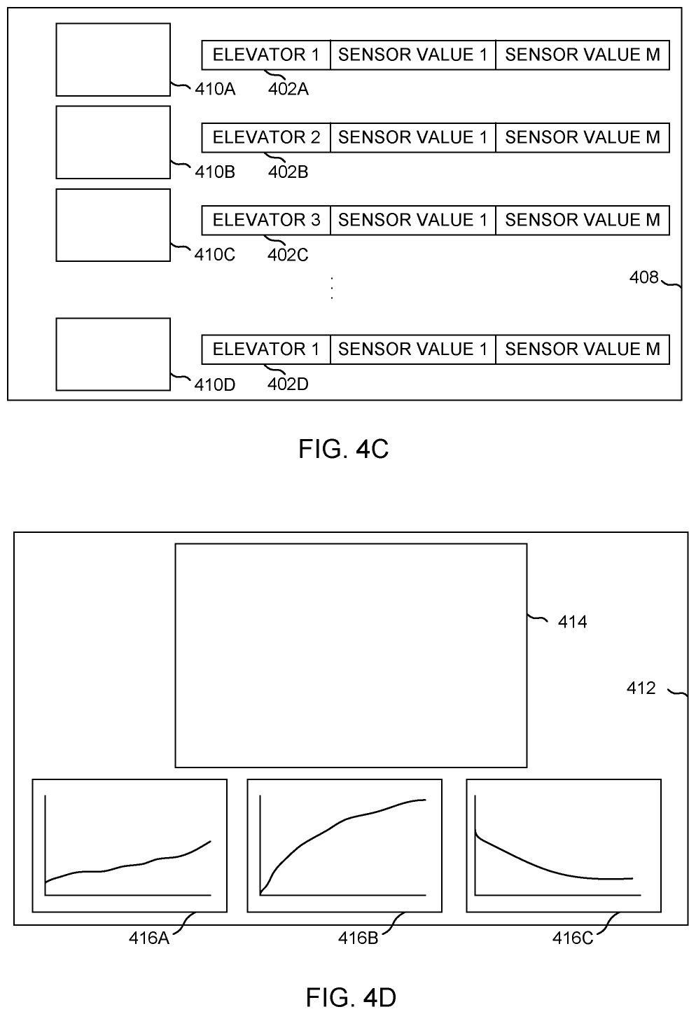

FIG. 4A illustrates a simplified graphical user interface view 400 provided by the controller 100 according to an example embodiment. The view 400 may comprise a summary of sensor data 402A, 402B, 402C, 402D associated with a selected set of the plurality of sensors 104B, 106B, 116C, 124B, 124E, 124H, 128B, 128E, 128H. The summary may comprise, for example, current sensor values provided by the sensors 104B, 106B, 116C, 124B, 124E, 124H, 128B, 128E, 128H. The sensors may comprise any sensor that may be used to provide information useful in a fire emergency situation, for example, a temperature sensor, a carbon dioxide sensor, a carbon monoxide sensor, an air moisture sensor etc. The view 400 may be provided, for example, by the display node 116A arranged in the elevator car 114 or by a display node 118 connected to the switch 102C. The display node 118 may comprise, for example, a display node arranged at a fire service access level or in a command center.

FIG. 4B illustrates a simplified graphical user interface view 404 provided by the controller 100 according to another example embodiment. The view 404 may comprise a summary of sensor data 406A-406D associated with a selected set of the plurality of sensors 124B, 124E, 124H, 128B, 128E, 128H provided at the landing floors. The summary may comprise, for example, current sensor values provided by the sensors 124B, 124E, 124H, 128B, 128E, 128H. The sensors may comprise any sensor that may be used to provide information useful in a fire emergency situation, for example, a temperature sensor, a carbon dioxide sensor, a carbon monoxide sensor, an air moisture sensor etc. The view 404 may be provided, for example, by the display node 116A arranged in the elevator car 114 or by a display node 118 connected to the switch 102C. The display node 118 may comprise, for example, a display node arranged at a fire service access level or in a command center.

FIG. 4C illustrates a simplified graphical user interface view 408 provided by the controller 100 according to another example embodiment. The view 408 may comprise a summary of sensor data 402A, 402B, 402C, 402D associated with a selected set of the plurality of sensors 104B, 106B, 116C, 124B, 124E, 124H, 128B, 128E, 128H and image frames 410A-410D. Each image frame 410A-410D may be associated with a different camera of the plurality of cameras 104A, 106A, 116B, 124A, 124D, 124G, 128A, 128D, 128G. The sensors may comprise any sensor that may be used to provide information useful in a fire emergency situation, for example, a temperature sensor, a carbon dioxide sensor, a carbon monoxide sensor, an air moisture sensor etc. The view 408 may be provided, for example, by the display node 116A arranged in the elevator car 114 or by a display node 118 connected to the switch 102C. The display node 118 may comprise, for example, a display node arranged at a fire service access level or in a command center.

In an example embodiment, if the display node is arranged in the elevator car 114, the display node may display image data and sensor data from sensors and cameras associated with the landing floors server by the elevator car 114. In another example embodiment, if the display node is arranged at a fire service access level (FSAL) or in a command center, the display node may be configured to display image and/or sensor data relating multiple elevators and landing floors served by the elevators.

The controller 100 may be configured to receive information indicating a selection of a miniature image frame and provide an expanded image frame for the selected miniature frame. The term “expanded image frame” may refer to a larger window that shows the image data in a larger form compared to the miniature image frame. A user standing in the elevator car 114 may select one of the miniature image frames 410A-410D, for example, using a touch-sensitive display 116A arranged in the elevator car 114. Or, a user operating at a command center or a fire service access level may select the miniature image frame from a touch-sensitive display.

FIG. 4D illustrates a simplified graphical user interface view 412 provided by the controller 100 according to another example embodiment. The view 412 may be provided, for example, a when user selects one of the image frames 410A-410D illustrated in FIG. 4C in order to obtain more information relating to a specific elevator or landing floor. The selection may have been made using a touch-sensitive feature of a display providing the view 412. In another example embodiment, in a case where the display is arranged in an elevator car, the user may use the car call buttons to select a desired landing floor from which more detailed information is needed.

The view 412 may comprise an expanded/larger image frame 414 that provides still or live image data from the selected elevator or landing floor. This makes it possible, for example, for the rescue personnel to obtain more accurate information about the elevator or landing floor. The view 412 may also provide more detailed information based on the sensor or sensors arranged in the elevator or landing floor. For example, various graphs 416A-416C may be provided that show how the situation has progressed over the time. For example, the graph 416A may illustrate the temperature in the time domain, the graph 416B may illustrate the carbon dioxide level in the time domain etc. This may give valuable information for the rescue personnel to estimate what the situation is currently and how it has progressed over the time.

At least some of the above discussed example embodiments may enable transmission of any device data seamlessly between elevator system devices and any other device or system. Further, a common protocol stack may be used for all communication. Further, at least some of the above discussed example embodiments may enable a solution in which a person in an elevator car or at other locally arranged location is able to see real-time image and sensor data from an elevator, a landing floor or landing floors in a fire emergency situation and makes decisions based on the obtained image and sensor data.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator communication system, comprising:
an elevator communication network configured to carry elevator system associated data;
a plurality of elevator system nodes communicatively connected to the elevator communication network, wherein at least some of the plurality of elevator system nodes each comprises a camera associated with an elevator and/or landing floor served by the elevator and configured to provide image data about the elevator and/or the landing floor, wherein at least some of the plurality of elevator system nodes each comprises a sensor associated with an elevator and/or a landing floor served by the elevator and configured to provide sensor data for at least one parameter associated with the elevator and the landing floor, and wherein at least one of the plurality of elevator system nodes, comprises a display node; and
a controller communicatively connected to the elevator communication network and being configured to
obtain image data from a plurality of cameras and sensor data from a plurality of sensors during a fire emergency situation; and
cause display, during the fire emergency situation, with the at least one display node a graphical user interface comprising image data and sensor data associated with a selected set of the plurality of cameras and sensors.

2. The elevator communication system of claim 1, wherein the graphical user interface comprises a summary of sensor data associated with the selected set of the plurality of sensors.

3. The elevator communication system of claim 1, wherein the graphical user interface comprises a separate miniature image frame for image data of each camera.

4. The elevator communication system of claim 1, wherein the controller is configured to:
receive information indicating a selection of a landing floor; and
provide more detailed sensor data associated with the selected landing floor.

5. The elevator communication system of claim 1, wherein the controller is configured to:
receive information indicating a selection of a landing floor; and
provide an expanded image frame comprising image data associated with the selected landing floor and more detailed sensor data associated with the selected landing floor.

6. The elevator communication system of claim 4, wherein the information indicating a selection of a landing floor is received in response to a selection of the landing floor via the graphical user interface.

7. The elevator communication system of claim 4, wherein the information indicating a selection of a landing floor is received in response to a selection of the landing floor via a car call button in an elevator car.

8. The elevator communication system of claim 1, wherein the sensor data associated with the selected set of the plurality of sensors associated with the elevators and the landing floors served by the elevators comprises a progression of the at least one parameter in time domain.

9. The elevator communication system of claim 1, wherein the plurality of sensors comprises at least one of a temperature sensor, a carbon monoxide sensor, an air moisture sensor, and a carbon dioxide sensor.

10. The elevator communication system of claim 1, wherein the display node comprises at least one of a display node arranged in an elevator car, a display node arranged at a fire service access level, and a display node arranged in a command center.

11. The elevator communication system of claim 1, wherein the elevator communication network comprises at least one point-to-point ethernet network.

12. The elevator communication system of claim 1, wherein the elevator communication network comprises at least one multi-drop ethernet segment.

13. A method comprising:
obtaining, by a controller communicatively connected to an elevator communication network, image data from a plurality of cameras communicatively connected to the elevator communication network and sensor data from a plurality of sensors communicatively connected to the elevator communication network during a fire emergency situation, each of the plurality of cameras being associated with an elevator and/or a landings floor served by the elevator and configured to provide image data about the elevator and/or the landing floor, each of the plurality of sensors being associated with an elevator and/or a landing floor served by the elevator and configured to provide sensor data for at least one parameter associated with the elevator and/or the landing floor; and
causing display, by the controller, during the fire emergency situation, with at least one display node communicatively connected to the elevator communication network a graphical user interface comprising image data and sensor data associated with a selected set of the plurality of cameras and sensors.

14. The method of claim 13, wherein the graphical user interface comprises a summary of sensor data associated with the selected set of the plurality of sensors.

15. The method of claim 13, wherein the graphical user interface comprises a separate miniature image frame for image data of each camera.

16. The method claim 13, further comprising:
receiving information indicating a selection of a landing floor; and
providing more detailed sensor data associated with the selected landing floor.

17. The method of claim 13, further comprising:
receiving information indicating a selection of a landing floor; and
providing an expanded image frame comprising image data associated with the selected landing floor and more detailed sensor data associated with the selected landing floor.

18. The method of claim 16, wherein the information indicating a selection of a landing floor is received in response to a selection of the landing floor via the graphical user interface.

19. The method of claim 16, wherein the information indicating a selection of a landing floor is received in response to a selection of the landing floor via a car call button in an elevator car.

20. The method of claim 13, wherein the sensor data associated with the selected set of the plurality of sensors associated with the elevators and the landings floors served by the elevators comprises a progression of the at least one parameter in time domain.

21. The method of claim 13, wherein the plurality of sensors comprises at least one of a temperature sensor, a carbon monoxide sensor, an air moisture sensor, and a carbon dioxide sensor.

22. The method of claim 13, wherein the display node comprises at least one of a display node arranged in an elevator car, a display node arranged at a fire service access level, and a display node arranged in a command center.

23. The method of claim 13, wherein the elevator communication network comprises at least one point-to-point ethernet network.

24. The method of claim 13, wherein the elevator communication network comprises at least one multi-drop ethernet segment.

25. An apparatus communicatively connected to an elevator communication network, the apparatus comprising:
means for obtaining image data from a plurality of cameras communicatively connected to the elevator communication network and sensor data from a plurality of sensors communicatively connected to the elevator communication network during a fire emergency situation, each of the plurality of cameras being associated with an elevator and/or a landing floor served by the elevator and configured to provide image data about the elevator and/or the landing floor, each of the plurality of sensors being associated with an elevator and/or a landing floor served by the elevator and configured to provide sensor data for at least one parameter associated with the elevator and/or the landing floor; and
means for causing display during the fire emergency situation, with at least one display node communicatively connected to the elevator communication network a graphical user interface comprising image data and sensor data associated with a selected set of the plurality of cameras and sensors.

26. An elevator system comprising the elevator communication system of claim 1.

27. (canceled)

28. A non-transitory computer readable medium comprising program code, which when executed by at least one processor, causes the at least one processor to perform the method of claim 13.
